(19) United States
(12) Patent Application Publication
(10) Pub. No.: US 2015/0229144 A1
(43) Pub. Date: Aug. 13, 2015

(54) BATTERY MANAGEMENT SYSTEM

(71) Applicant: SAMSUNG SDI CO., LTD., Yongin-si (KR)

(72) Inventors: Jin-Soo JANG, Yongin-si (KR); Jae-Sung GU, Yongin-si (KR)

(21) Appl. No.: 14/596,486

(22) Filed: Jan. 14, 2015

(30) Foreign Application Priority Data
Feb. 10, 2014 (KR) 10-2014-0015115

(51) Int. Cl. H02J 7/00

(52) U.S. Cl. CPC H02J 7/0021

(57) ABSTRACT

A battery management system includes a battery pack, a resistive path, and a redundant resistive path. The battery pack includes a first output terminal and a second output terminal connected to a load. The redundant resistive path is between a first output terminal of the battery pack and the first outer terminal. The resistive path is between the second output terminal of the battery pack and a second output terminal. The controller is to detect overcurrent flowing through the battery pack using the redundant resistive path and the resistive path.

### CROSS-REFERENCE TO RELATED APPLICATION

Korean Patent Application No. 10-2014-0015115, filed on Feb. 10, 2014, and entitled, “Battery Management System,” is incorporated by reference herein in its entirety.

### BACKGROUND

1. Field

One or more embodiments described herein relate to a battery.

2. Description of the Related Art

A rechargeable battery is capable of being repeatedly charged and discharged. Examples of rechargeable batteries include a nickel-metal hydride (Ni-MH) battery and a lithium (Li) ion battery. Rechargeable batteries are used as power sources for mobile devices, electric vehicles, hybrid vehicles, and electrical device.

A low-capacity rechargeable battery is used in small portable electronic devices such as mobile phones, notebook computers, and camcorders. A high-capacity rechargeable battery is used as a power source for hybrid vehicles.

One type of rechargeable battery includes a battery pack and battery management system (BMS). The BMS controls charging and discharging operations for the battery pack through an outer terminal. One type of BMS measures current flowing through the battery pack using a shunt resistor located between the battery pack and the outer terminal. The BMS converts voltage applied between opposite ends of the shunt resistor into a current, for purposes of determining whether an overcurrent flows or not.

### SUMMARY

In accordance with one embodiment, a battery management system includes a battery pack including a plurality of battery cells; a first outer terminal and a second outer terminal to connect the battery pack to a load; a redundant resistive path between a first output terminal of the battery pack and the first outer terminal; a resistive path between a second output terminal of the battery pack and the second output terminal; and a controller to detect overcurrent flowing through the battery pack using the redundant resistive path and the resistive path.

The redundant resistive path may include a bus bar and a relay connected in series between the first output terminal and the first outer terminal. The redundant resistive path may include a bus bar and a fuse connected in series between the first output terminal and the first outer terminal.

The system may include a current detector to calculate a first charge/discharge current flowing through the resistive path based on a resistance of the resistive path and a voltage between ends of the resistive path. The controller may calculate a second charge/discharge current flowing through the redundant resistive path based on a resistance of the redundant resistive path and the voltage between ends of the redundant resistive path, and may determine an abnormal state of the resistive path based on a comparison between the first and second charge/discharge currents. The controller may detect an overcurrent flowing through the battery pack based on the second charge/discharge current when an abnormality exists in the resistive path.

The system may include an amplifier to amplify a voltage between ends of the redundant resistive path. The first output terminal may be connected to a positive electrode terminal of the battery pack, and the second output terminal may be connected to a negative electrode terminal of the battery pack.

In accordance with another embodiment, a battery management system includes a battery pack including a plurality of battery cells; a first outer terminal and a second outer terminal to connect the battery pack to a load; a first resistive path between a negative electrode terminal of the battery pack and the second outer terminal; a bus bar and a second resistive path between a positive electrode terminal of the battery pack and the first outer terminal; and a controller to detect an overcurrent flowing through the battery pack based on a first charge/discharge current flowing through the first resistive path and a second charge/discharge current flowing through the bus bar and second resistive path.

The second resistive path may include a relay connected in series with the bus bar. The second resistive path may include a fuse connected in series with the bus bar. The system may include a current detector to detect a voltage between ends of the first resistive path, and to calculate a first charge/discharge current based on a resistance of the first resistive path and the voltage between ends of the first resistive path.

The system may include an amplifier to amplify a voltage between ends of the bus bar and second resistive path.

The controller may calculate a second charge/discharge current based on resistances of the bus bar and second resistive path and the voltage output from the amplifier, and may detect overcurrent of the battery pack based on at least one of the first or second charge/discharge current.

The controller may detect overcurrent of the battery pack based on the first charge/discharge current when a difference between the first and second charge/discharge currents falls within a predetermined range, and may detect an overcurrent of the battery pack based on the second charge/discharge current when a difference between the first and second charge/discharge currents exceeds the predetermined range. The controller may disconnect the battery pack from the first and second outer terminals when overcurrent flows through the battery pack.

In accordance with another embodiment, an apparatus includes a first resistive path; a second resistive path; and a controller coupled to the first and second resistive paths, wherein the controller is to determine an abnormal condition of a battery pack based on at least one of a current through the first resistive path and a current through the second resistive path, and wherein the controller is to determine the abnormal condition of the battery pack based on the resistance of the second resistive path when the first resistive path is in an abnormal state.

The first resistive path may include a shunt resistor, and the second resistive path may include at least one of a bus bar, a fuse, or a relay. The abnormal condition of the battery pack may be based on malfunction of the shut resistor. The abnormal condition of the battery pack may include overcurrent flowing through the battery pack.

### BRIEF DESCRIPTION OF THE DRAWINGS

FIG. 1 illustrates an embodiment of a battery management system; and

FIG. 2 illustrates an embodiment of a method for managing a battery pack.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

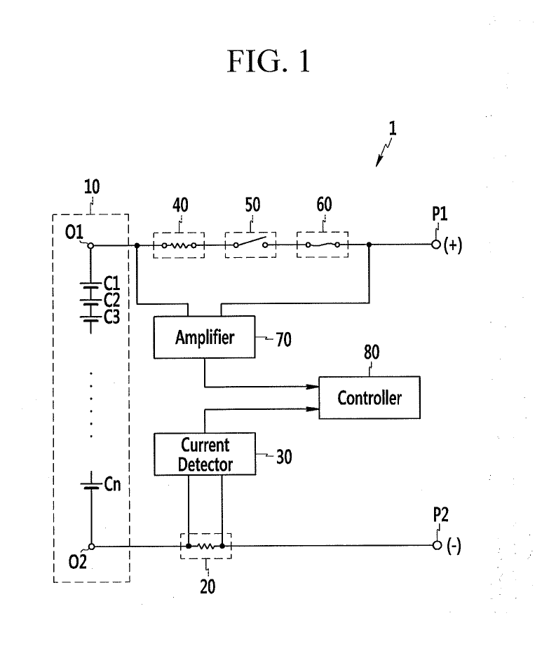

FIG. 1 illustrates an embodiment of a battery management system 1 which includes a battery pack 10, a shunt resistor 20, a current detector 30, a bus bar 40, a relay 50, a fuse 60, an amplifier 70, a controller 80, a first outer terminal P1, and a second outer terminal P2.

The battery pack 10 includes a plurality of battery cells C1 to Cn, a first output terminal O1, and a second output terminal O2. The plurality of battery cells C1 to Cn may respectively have a structure including an electrode assembly having a positive electrode plate and a negative electrode plate, with a separator interposed therebetween and being disposed at lateral sides thereof. A case is included for accommodating the electrode assembly. A positive electrode terminal is electrically connected to the positive electrode plate, and a negative electrode terminal is electrically connected to the negative electrode plate. The battery cells C1 to Cn may each be a lithium-ion secondary battery, a lithium polymer battery, or another type of rechargeable battery.

The positive electrode terminal of battery pack 10 is connected to first output terminal O1. The negative electrode terminal is connected to second output terminal O2. The first and second output terminals O1 and O2 are electrically connected to first and second outer terminals P1 and P2, respectively. The first and second output terminals O1 and O2 are connected to an external load through first and second outer terminals P1 and P2. The external load may include a charger, a motor, etc. The battery pack 10 may be used in an electric vehicle, an electric bike, or in another application.

Shunt resistor 20 is disposed on a high current path between second output electrode O2 and second outer terminal P2. In one embodiment, the shunt resistor may have a fixed resistance.

Current detector 30 detects a first charge/discharge current flowing through shunt resistor 20 and transmits the current (or corresponding information) to controller 80. Current detector 30 may calculate the first charge/discharge current using the resistance of shunt resistor 20 and a voltage between ends of shunt resistor 20.

Bus bar 40, relay 50, and fuse 60 are disposed on the high current path between first output terminal O1 and first outer terminal P1, and are connected to each other in series. Bus bar 40, relay 50, and fuse 60 are resistive elements having predetermined internal resistances, and act as redundant resistive elements along with shunt resistor 20 when measuring current flowing in the high current path. In one embodiment, at least one of relay 50 and fuse 60 may be omitted.

Further, bus bar 40, relay 50, and fuse 60 may be connected in different sequences. Bus bar 40 electrically connects first output terminal O1 with first outer terminal P1. Bus bar 40 may be made of any one of a variety of conductive materials.

Relay 50 is controlled by controller 80 to selectively connect first output terminal O1 with first outer terminal P1.

Fuse 60 is melted to cut off the high current path when a large amount of current exceeding a predetermined level flows between first output terminal O1 and first outer terminal P1.

Amplifier 70 amplifies a voltage between opposite ends of bus bar 40, relay 50, and fuse 60, and transmits information corresponding to the voltage to controller 80.

In one embodiment, if BMS 1 has a configuration in which one of relay 50 or fuse 60 is omitted, amplifier 70 may amplify a voltage between ends of bus bar 40 and relay 50, or a voltage between ends of bus bar 40 and fuse 60. The voltage (or corresponding information) may then be transmitted to controller 80.

The controller 80 calculates a second charge/discharge current flowing through bus bar 40, relay 50, and fuse 60 using the voltage between the ends of bus bar 40, relay 50, and fuse 60 (which voltage is amplified by amplifier 70) and respective resistances of bus bar 40, relay 50, and fuse 60.

Subsequently, controller 80 determines whether an abnormality of shunt resistor 20 exists by comparing the first charge/discharge current and second charge/discharge current. For example, controller 80 may determine that shunt resistor 20 is abnormal depending on whether a difference between the first and second charge/discharge currents falls within a predetermined range.

In one embodiment, controller 80 determines that shunt resistor 20 is in a normal state when the difference between the first and second charge/discharge currents falls within the predetermined range. Controller 80 may then detect whether the overcurrent flows through the battery pack 10 or not by the first charge/discharge current that flows through shunt resistor 20.

Controller 80 may determine that shunt resistor 20 is in an abnormal state when the difference between the first and second charge/discharge currents exceeds the predetermined range. Controller 80 may then detect whether overcurrent flows through battery pack 10 or not by the second charge/discharge current that flows through bus bar 40, relay 50, and fuse 60.

If shunt resistor 20 is in the normal state, controller 80 determines whether the first charge/discharge current exceeds the predetermined level. If it does, controller 80 determines that overcurrent is flowing through battery pack 10.

If shunt resistor 20 is in the abnormal state, controller 80 determines whether the second charge/discharge current exceeds the predetermined level. If it does, controller 80 determines that the overcurrent flows through battery pack 10.

Controller 80 electrically disconnects battery pack 10 from first and second outer terminals P1 and P2 it is determined that an overcurrent is flowing through battery pack 10. For example, controller 80 may electrically disconnect first output terminal O1 from first outer terminal P1 through relay 50.

Further, if shunt resistor 20 is in the abnormal state, controller 80 may request replacement of shunt resistor 20 to a user through an external interface. For example, controller 80 may use bus bar 40, relay 50, and fuse 60 as a redundant resistive element, instead of shunt resistor 20, to measure the charge/discharge current flowing through battery pack 10. Based on this measurement, overcurrent may be detected to be flowing through battery pack 10, even shunt resistor 20 is in an abnormal state.

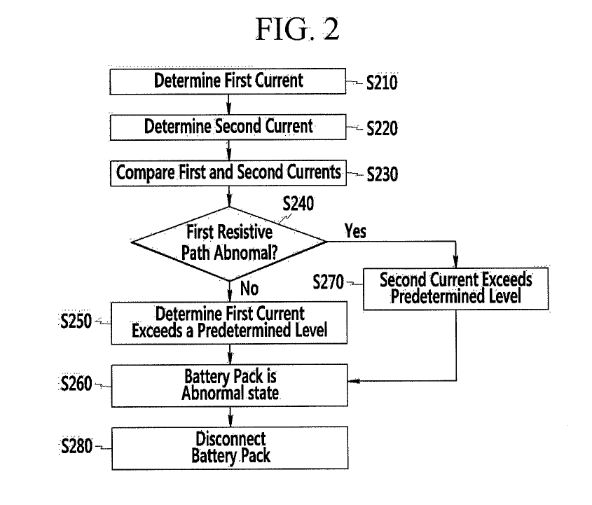

FIG. 2 illustrates an embodiment of a method for managing a battery pack. The battery pack may be the one in FIG. 1 and one or more of the operations of the method may be performed by the battery management system of FIG. 1.

Initially, the method includes determining first current flowing through a first resistive path coupled to the battery pack (S210). The first resistive path may include shunt resistor 20. The method further includes determining second current flowing through a second resistive path coupled to the battery pack (S220). The first and second currents are then compared (S230). The second resistive path may include on or more of bus bar 40, relay 50, and fuse 60, as previously described.

Based on the comparison, a determination is made as to whether the first resistive path is in an abnormal state (S240). This may involve determining whether shunt resistor 20 is inoperative or otherwise malfunctioning, as previously discussed. If the first resistive path is not in an abnormal state, a determination is made as to whether the first current exceeds a predetermined level (S250). If the first current exceeds the predetermined level, the battery pack is determined to be in an abnormal state (S260). If the first current does not exceed the predetermined level, then the battery pack may be determined not to be in an abnormal state.

If the first resistive path is determined to be abnormal, a determination is made as to whether the second current exceeds a predetermined level (S270). The predetermined level in operation S270 may be the same or different from the predetermined level in operation S250. If the second current exceeds the predetermined level, then the battery pack is determined to be in an abnormal state. If the second current does not exceed the predetermined level, then a determination is made that the battery pack is not in an abnormal state.

Once the battery pack is determined to be in an abnormal state, various corrective actions may be taken. For example, the battery pack may be disconnected as previously described (S280). Additionally, or alternatively, a user may be notified that shunt resistor 20 is not properly operating and is to be replaced.

In accordance with another embodiment, a computer-readable medium stores a computer program or code for performing all or a portion of the operations of the method in FIG. 2. The computer-readable medium may be a volatile or non-volatile memory, and the code may be written in any form executable by a processor or controller, such as controller 80 in FIG. 1.

By way of summation and review, one type of rechargeable battery includes a battery pack and battery management system (BMS). The BMS controls charging and discharging operations for the battery pack through an outer terminal. One type of BMS measures current flowing through the battery pack using a shunt resistor located between the battery pack and the outer terminal. The BMS converts voltage applied between opposite ends of the shunt resistor into a current, for purposes of determining whether an overcurrent flows or not.

In operation, there is a high risk of explosion if overcurrent flows through the battery pack. Therefore, current flowing through the battery pack is measured. However, if an abnormality occurs in the shunt resistor itself, it may not be possible to measure the current through the battery pack.

In accordance with one embodiment, a redundant resistive path is provide for purposes of determining whether an abnormal condition exists in the battery pack. The abnormal condition may be an overcurrent condition or another abnormal condition. Using the redundant resistive path, the battery pack may be determined to be in an abnormal state even when, for example, a shunt resistor along another resistive path is not properly operating.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A battery management system, comprising:
a battery pack including a plurality of battery cells;
a first outer terminal and a second outer terminal to connect the battery pack to a load;
a redundant resistive path between a first output terminal of the battery pack and the first outer terminal;
a resistive path between a second output terminal of the battery pack and the second output terminal; and
a controller to detect overcurrent flowing through the battery pack using the redundant resistive path and the resistive path.

2. The system as claimed in claim 1, wherein the redundant resistive path includes a bus bar and a relay connected in series between the first output terminal and the first outer terminal.

3. The system as claimed in claim 1, wherein the redundant resistive path includes a bus bar and a fuse connected in series between the first output terminal and the first outer terminal.

4. The system as claimed in claim 1, further comprising:
a current detector to calculate a first charge/discharge current flowing through the resistive path based on a resistance of the resistive path and a voltage between ends of the resistive path.

5. The system as claimed in claim 4, wherein the controller is to:
calculate a second charge/discharge current flowing through the redundant resistive path based on a resistance of the redundant resistive path and the voltage between ends of the redundant resistive path, and
determine an abnormal state of the resistive path based on a comparison between the first and second charge/discharge currents.

6. The system as claimed in claim 5, wherein the controller is to detect an overcurrent flowing through the battery pack based on the second charge/discharge current when an abnormality exists in the resistive path.

7. The system as claimed in claim 1, further comprising:
an amplifier to amplify a voltage between ends of the redundant resistive path.

8. The system as claimed in claim 1, wherein:
the first output terminal is connected to a positive electrode terminal of the battery pack, and
the second output terminal is connected to a negative electrode terminal of the battery pack.

9. A battery management system, comprising:
a battery pack including a plurality of battery cells;
a first outer terminal and a second outer terminal to connect the battery pack to a load;
a first resistive path between a negative electrode terminal of the battery pack and the second outer terminal;
a bus bar and a second resistive path between a positive electrode terminal of the battery pack and the first outer terminal; and
a controller to detect an overcurrent flowing through the battery pack based on a first charge/discharge current flowing through the first resistive path and a second charge/discharge current flowing through the bus bar and second resistive path.

10. The system as claimed in claim 9, wherein the second resistive path includes a relay connected in series with the bus bar.

11. The system as claimed in claim 9, wherein the second resistive path includes a fuse connected in series with the bus bar.

12. The system as claimed in claim 9, further comprising:
a current detector to detect a voltage between ends of the first resistive path, and to calculate a first charge/discharge current based on a resistance of the first resistive path and the voltage between ends of the first resistive path.

13. The system as claimed in claim 9, further comprising:
an amplifier to amplify a voltage between ends of the bus bar and second resistive path.

14. The system as claimed in claim 13, wherein the controller is to:
calculate a second charge/discharge current based on resistances of the bus bar and second resistive path and the voltage output from the amplifier, and
detect overcurrent of the battery pack based on at least one of the first or second charge/discharge current.

15. The system as claimed in claim 14, wherein the controller is to:
detect overcurrent of the battery pack based on the first charge/discharge current when a difference between the first and second charge/discharge currents falls within a predetermined range, and
detect an overcurrent of the battery pack based on the second charge/discharge current when a difference between the first and second charge/discharge currents exceeds the predetermined range.

16. The system as claimed in claim 15, wherein the controller is to disconnect the battery pack from the first and second outer terminals when overcurrent flows through the battery pack.

17. An apparatus, comprising:
a first resistive path;
a second resistive path; and
a controller coupled to the first and second resistive paths,
wherein the controller is to determine an abnormal condition of a battery pack based on at least one of a current through the first resistive path and a current through the second resistive path, and wherein the controller is to determine the abnormal condition of the battery pack based on the current of the second resistive path when the first resistive path is in an abnormal state.

18. The apparatus as claimed in claim 17, wherein:
the first resistive path includes a shunt resistor, and
the second resistive path includes at least one of a bus bar, a fuse, or a relay.

19. The apparatus as claimed in claim 18, wherein the abnormal condition of the battery pack is based on malfunction of the shunt resistor.

20. The apparatus as claimed in claim 17, wherein the abnormal condition of the battery pack includes overcurrent flowing through the battery pack.
